(19) United States
(12) Patent Application Publication
(10) Pub. No.: US 2014/0064711 A1
(43) Pub. Date: Mar. 6, 2014

(54) Systems, Methods, and Media for Presenting Media Content Using Cached Assets

(71) Applicants: Benjamin H. Ziskind, San Diego, CA (US); Jason A. Braness, San Diego, CA (US)

(72) Inventors: Benjamin H. Ziskind, San Diego, CA (US); Jason A. Braness, San Diego, CA (US)

(21) Appl. No.: 13/596,714

(22) Filed: Aug. 28, 2012

(51) Int. Cl. H04N 5/93

(52) U.S. Cl. 386/353; 386/E05.028

(57) ABSTRACT

Processing circuitry configured to: store a portion of a piece of media content common to a plurality of different pieces of media content; after storing the portion, receive a user request to present one of the plurality of different pieces of media content; access a manifest for the one of the plurality of different pieces of media content; based on the manifest, determine that, the portion is part of the one of the plurality of different pieces of media content; play back the portion of the piece of media content, common to the plurality of different pieces of media content; and while playing back the portion of the piece of media content common to the plurality of different pieces of media content, establish a stream of another piece of the one of the plurality of different pieces of media content.

### BACKGROUND OF THE INVENTION

When starting an adaptive video stream, there is usually some amount of delay before playback begins while the client and the server negotiate the appropriate bitrates and. begin transferring the first few seconds of the video. Such delays can be annoying to users of such video streams.

Accordingly, systems, methods, and media for presenting media content, using cached assets are provided.

### SUMMARY OF THE INVENTION

In view of the foregoing, systems, methods, and media for presenting media content using cached assets are provided.

In particular, in some embodiments, systems for presenting media content using cached assets are provided. In some embodiments, the systems comprise processing circuitry configured to: store a portion of a piece of media content common to a plurality of different pieces of media content; after storing the portion of the piece of media content common to the plurality of different pieces of media content, receive a user request to present one of the plurality of different pieces of media content; access a manifest for the one of the plurality of different pieces of media content; based on the manifest, determine that the portion of the media content common to the plurality of different pieces of media content is part of the one of the plurality of different pieces of media content; play back the portion of the piece of media content common to the plurality of different pieces of media content; and while playing back the portion of the piece of media content common to the plurality of different pieces of media content, establish a stream of another piece of the one of the plurality of different pieces of media content.

In some embodiments, methods for presenting media content using cached assets are provided. In some embodiments, the methods comprise; storing a portion of a piece of media content common to a plurality of different pieces of media content by processing circuitry; after storing the portion of the piece of media content common to the plurality of different pieces of media content, receiving a user request to present one of the plurality of different pieces of media content at the processing circuitry; accessing a manifest for the one of the plurality of different pieces of media content by the processing circuitry; based on the manifest, determining that the portion of the media content common to the plurality of different pieces of media content is part of the one of the plurality of different pieces of media content by the processing circuitry; playing back the portion of the piece of media content common to the plurality of different pieces of media content by the processing circuitry; and while playing back the portion of the piece of media content common to the plurality of different pieces of media content, establishing a stream of another piece of the one of the plurality of different pieces of media, content by the processing circuitry.

In some embodiments, non-transitory computer-readable media containing computer-executable instructions that, when executed by a processor, cause the processor to perform a method for presenting media content using cached assets are provide. In some embodiments, the method comprises: storing a portion of a piece of media content common to a plurality of different pieces of media content; after storing the portion of the piece of media content common to the plurality of different pieces of media content, receiving a user request to present one of the plurality of different pieces of media content; accessing a manifest for the one of the plurality of different pieces of media content; based on the manifest, determining that the portion of the media content common to the plurality of different pieces of media content is part of the one of the plurality of different pieces of media content; playing back the portion of the piece of media content common to the plurality of different pieces of media content; and while playing back the portion of the piece of media content common to the plurality of different pieces of media content, establishing a stream of another piece of the one of the plurality of different pieces of media content.

### BRIEF DESCRIPTION OF THE DRAWINGS

The above and other objects and advantages of

the invention will be apparent upon consideration of the following detailed description, taken in conjunction with the accompanying drawings, in which like reference characters refer to like parts throughout, and in which:

FIG. 1 shows an example of an interactive media guidance application display that, can be used with a process for selecting media content for presentation in accordance with some embodiments of the invention;

FIG. 2 shows an example of a. block diagram of hardware that can foe used in accordance with some embodiments of the invention;

FIG. 3 shows an example of a block diagram of user equipment device hardware that can be used in accordance with some embodiments of the invention;

FIG. 4 shows an example of a flow diagram of a process for caching assets in accordance with some embodiments of the invention;

FIG. 5 shows an example of a more detailed flow diagram of a playback process in accordance with some embodiments of the invention;

FIG. 6 shows an example of a more detailed flow diagram of a process for ingesting a piece of media content in accordance with some embodiments of the invention; and

FIG. 7 shows an example of an XML file for storing a manifest in accordance with some embodiments of the invention.

### DETAILED DESCRIPTION OF EMBODIMENTS

This invention generally relates to systems, methods, and media for presenting media content using cached assets. More particularly, in some embodiments, one or more portions (each an asset) of a piece of media content being presented can be presented from a cache of assets that are common to multiple pieces of media content. In some embodiments, processes for ingesting a piece of media content to identify common portions, for caching one or more common portions of media content, and for playing back media content can be provided.

For example, in some embodiments, multiple pieces of media content (e.g., movies) may begin with the same pre-roll branding for the service (e.g., an animation identifying the branding of the service, such as CinemaRow), the same pre-roll branding for the content owner (e.g., an animation identifying the studio licensing the title, such as ABC, Disney, etc.), the same pre-roll advertising, the same legal warnings (e.g., an FBI anti-copy warning), the same opening credits of television episodes, etc. Such common portions can be identified, cached locally to a viewer so that those portions can be presented while a stream of other portions is being established, and played back when the viewer requests to be presented with media content. Cached assets can be audio and video, audio only, video only, text, graphics, images, etc. in some embodiments.

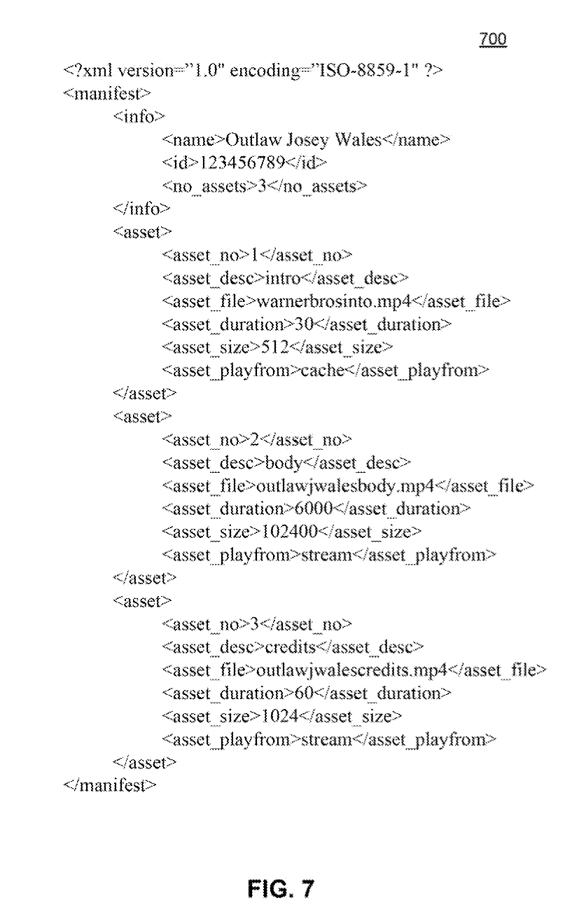

In some embodiments, media content, such as movies, television shows, televised sporting events, etc., can be presented to a media content user as a set of assets in a manner controlled by a manifest for the set of assets. Assets can be audio/video flies, video-only files, audio-only files, closed captioning files, text files, image files, graphics files, etc. in some embodiments. A manifest can be a set. of instructions, a list, a specification, etc. for controlling the manner in which a set of assets are presented (e.g., the order of playback, the source from which playback is effected (e.g., from cache, from stream, etc.), etc.) in some embodiments. A manifest can be in any suitable format, sued as in the Synchronized Multimedia Integration Language (SMIL) or an XML file (as illustrated, for example, in XML file 700 of FIG. 7), in some embodiments. For example, in some embodiments, a movie can foe presented using a single audio/video file (an asset) as controlled by a user equipment device processing a manifest for the movie which specifies that the movie can be presented by playing the single audio/video file. As another example, a television program can foe presented using a video-only file and an audio-only file for an opening segment and then one or more audio/video files for subsequent segment(s) as controlled by a user equipment device processing a manifest for the program which specifies that the movie can be presented by first presenting the video-only file and the audio-only file concurrently and then presenting the audio/video file(s).

In some embodiments, one or more of the assets can foe stored locally to a user equipment device used to playback media content. For example, the one or more assets can be stored locally in order to speed-up the initial playback of the media content.

As referred to herein, the term “media content” should be understood to mean one or more electronically consumable media assets, such as television programs, pay-per-view programs, on-demand programs (e.g., as provided in video-on-demand (VOD) systems), Internet content, (e.g., streaming content, downloadable content, Webcasts, etc.), movies, films, video clips, audio, audio books, and/or any other media or multimedia and/or combination of the same. As referred to herein, the term “multimedia” should foe understood to mean media content that utilizes at least two different content forms described above, for example, text, audio, images, video, or interactivity content forms. Media content may be recorded, played, displayed or accessed by user equipment devices, but can also be part of a live performance. In some embodiment, media content can include over-the-top (OTT) content. Examples of OTT content providers include YOUTUBE, NETFLIX, and HULU, which provide audio and video via IP packets. Youtube is a trademark owned by Google Inc., Netflix is a trademark owned by Netflix Inc., and Hulu is a trademark owned by Hulu, LLC.

Media content can be provided from any suitable source in some embodiments. In some embodiments, media content can be electronically delivered to a user's location from a remote location. For example, media content, such as a Video-On-Demand movie, can be delivered to a user's home from a cable system server. As another example, media content, such as a television program, can foe delivered to a user's home from a streaming media provider over the Internet.

Media content to be presented can be selected in any suitable manner in some embodiments. For example, in some embodiments, media content can be selected by a user selecting the media content for presentation from an interactive media guidance application (which can also be referred to herein as a media guidance application or a guidance application).

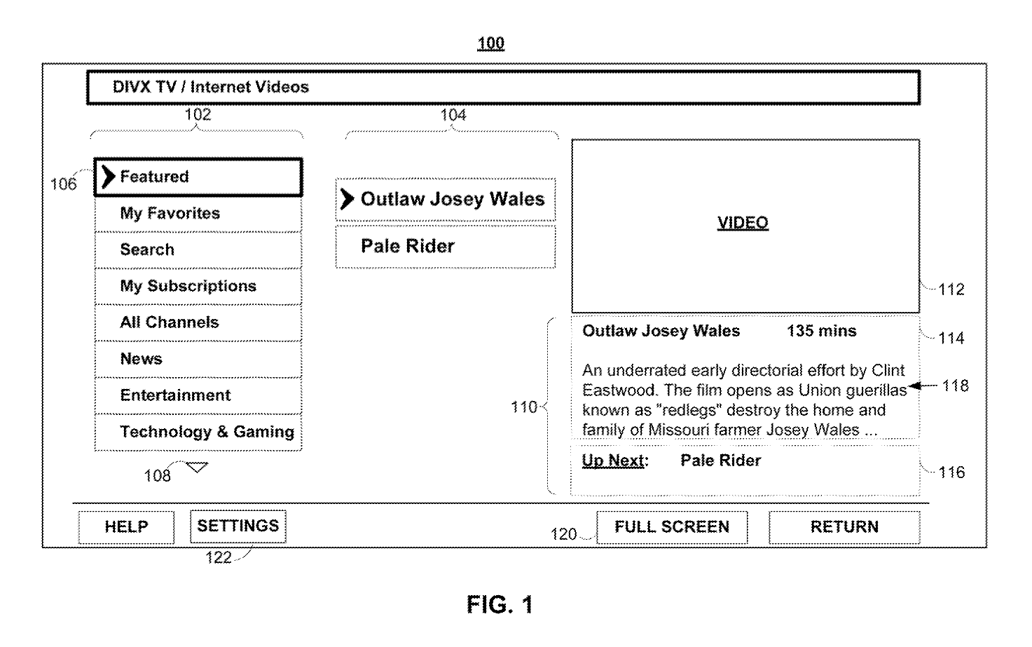

FIG. 1 shows an example 100 of a guidance display that can be provided as part of an interactive media guidance application in accordance with some embodiments. As illustrated, a user may be presented with display 100 in response to the user selecting a selectable option provided in a displayed menu (e.g., an “Internet Videos” option, a “DivXTV” option, a “Program Listings” option, etc.), pressing a dedicated button (e.g., a GUIDE button) on a user input interface or device, and/or taking any other suitable action.

As illustrated in FIG. 1, guidance display 100 may include lists of media identifiers, such as a first list of media identifiers 102 that lists categories of media content, and a second list of media identifiers 104 that lists particular pieces of media content within a selected category that are available for presentation.

Additional media guidance data, such as additional media identifiers, may be presented in response to a user selecting a navigational icon 108.

Display 100 may also include a media queue region 110 that lists one or more pieces of media content selected and queued for playback, and a video region 112 in which pieces of media content can be presented.

In some embodiments, information relating to a piece of media content can also be presented to a user. For example, information 118 can include a name of a piece of media content, a time at which the media content is available (if applicable), a source (e.g., channel, Web address, etc.) from which the media content, can be obtained, a parental rating for the piece of media content, a duration of the piece of media content, a description of the piece of media content, a review or a quality rating of the piece of media content, and/or any other suitable information.

In some embodiments, pieces of media content can be played in a full sized display screen in response to a user selecting “full screen” button 120.

In some embodiments, a user may be able to set settings related to the interactive media guidance application by pressing a settings button, such as settings button 120 of FIG. 1. The settings that can be set can include any suitable settings such as channel and program favorites, programming preferences that the guidance application can utilize to make programming recommendations, display preferences, language preferences, and/or any other suitable settings.

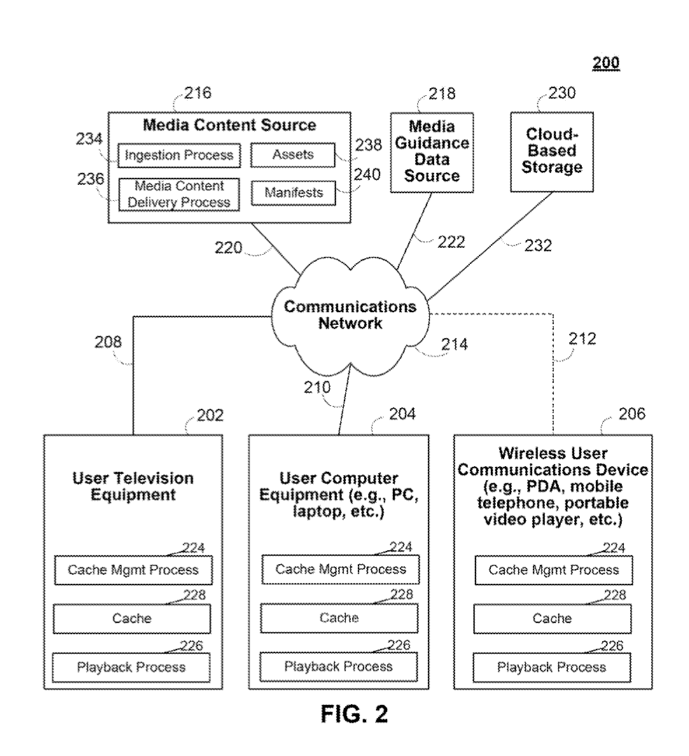

Turning to FIG. 2, an example 200 of an architecture of hardware that can be used in accordance with some embodiments is shown. As illustrated, architecture 200 can include a user television equipment device 202, a user computer equipment device 204, a wireless user communication device 206, a communications network 214, a media content, source 216, a media guidance data source 218, cloud-based storage 230, and communication paths 208, 210, 212, 220, 222, and 232.

In some embodiments, user television equipment device 202, user computer equipment device 204, and wireless user communication device 206, which can each foe referred to herein as a “user equipment device,” can be any suitable devices for presenting media content, presenting an interactive media guidance application for selecting content, and/or performing any other suitable functions as described herein.

User television equipment device 202 can be any suitable user television equipment device or devices in some embodiments. For example, in some embodiments, user television equipment device 202 can include any suitable television, smart TV, set-top box, integrated receiver decoder (IRD) for handling satellite television, digital storage device, digital media receiver (DMR), digital media adapter (DMA), streaming media device, DVD player, DVD recorder, connected DVD, local media server, BLU-RAY player, BLU-RAY recorder, any other suitable user television equipment, and/or any other suitable combination of the same.

User computer equipment 204 can be any suitable user computer equipment in some embodiments. For example, in some embodiments, user computer equipment 204 can include any suitable personal computer (PC), laptop computer, tablet computer, WebTV box, personal computer television (PC/TV), PC media server, PC media center, hand-held computer, stationary telephone, non-portable gaming machine, any other suitable user computer equipment, and/or any other suitable combination of the same.

Wireless user communication device 206 can be any suitable wireless user communication device or devices in some embodiments. For example, in some embodiments, wireless user communication device 206 can include any suitable personal digital assistant (PDA), mobile telephone, portable video player, portable music player, portable gaming machine, smart phone, any other suitable wireless device, and/or any suitable combination of the same.

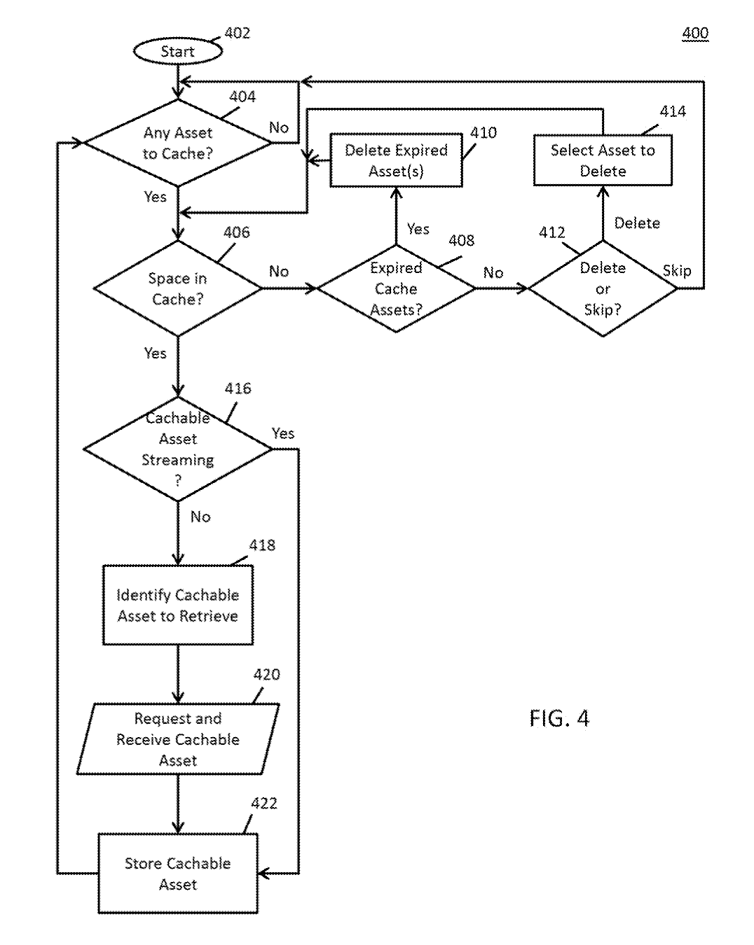

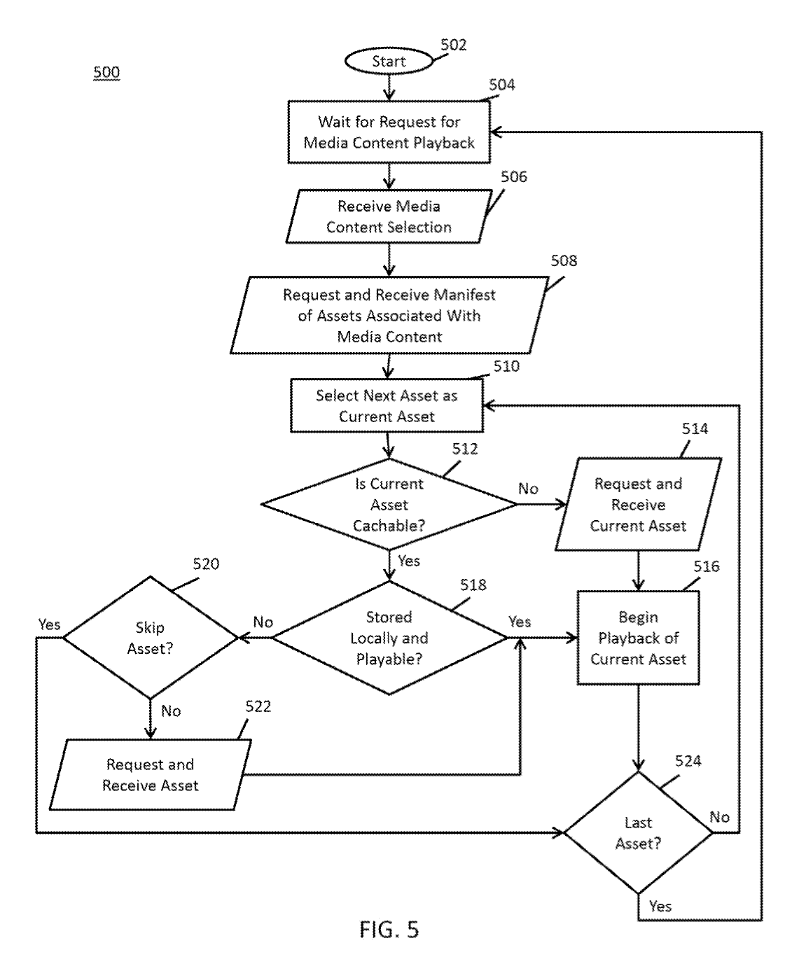

In some embodiments, as shown in FIG. 2, one or more of user equipment devices 202, 204, and 206 can include a cache management process 224, a playback process 226, and a cache 228. Cache management process 224 can be any suitable process for managing a cache of asset storage (such as cache 228). An example of a cache management, process that can foe used in some embodiments is shown in FIG. 4 and described further below. Playback process 226 can be any suitable process for controlling playback of one or more assets in accordance with some embodiments. An example of a playback process that can foe used in some embodiments is shown in FIG. 5 and described further below. Cache 228 can be any suitable storage for storing stored assets, such as for example a media server, a disk drive, a database, etc.

In some embodiments, user equipment devices may be connectable to a communications network. For example, in some embodiments, user equipment devices may be Internet-enabled allowing them to access Internet media content.

In some embodiments, communications network 214 may be any one or more networks including the Internet, a mobile phone network, a mobile voice, a mobile data network (e.g., a 3G, 4G, or LTE network), a cable network, a satellite network, a public switched telephone network, a local area network, a wide area network, any other suitable type of communications network, and/or any suitable combination of communications networks.

Media content source 216 may include one or more types of content distribution equipment for distributing any suitable media content, including television distribution facility equipment, cable system head-end equipment, satellite distribution facility equipment, programming source equipment (e.g., equipment of television broadcasters, such as NBC, ABC, HBO, etc.), intermediate distribution facility equipment, Internet provider equipment, on-demand media server equipment, and/or any other suitable media content provider equipment. NBC is a trademark owned by the National Broadcasting Company, Inc., ABC is a trademark owned by the ABC, INC., and HBO is a trademark owned by the Home Box Office, Inc.

Media content source 216 may be operated by the originator of content (e.g., a television broadcaster, a Webcast provider, etc.) or may be operated by a party other than the originator of content (e.g., an on-demand content provider, an Internet provider of content of broadcast programs for downloading, etc.).

Media content source 216 may be operated by cable providers, satellite providers, on-demand providers, Internet providers, providers of over-the-top content, and/or any other suitable provider(s) of content.

Media content source 216 may include a remote media server used to store different types of content (including video content selected by a user), in a location remote from any of the user equipment devices. Systems and methods for remote storage of content, and providing remotely stored content to user equipment are discussed in greater detail in connection with Ellis et al U.S. Pat. No. 7,761,892, issued Jul. 20, 2010, which is hereby incorporated by reference herein in its entirety.

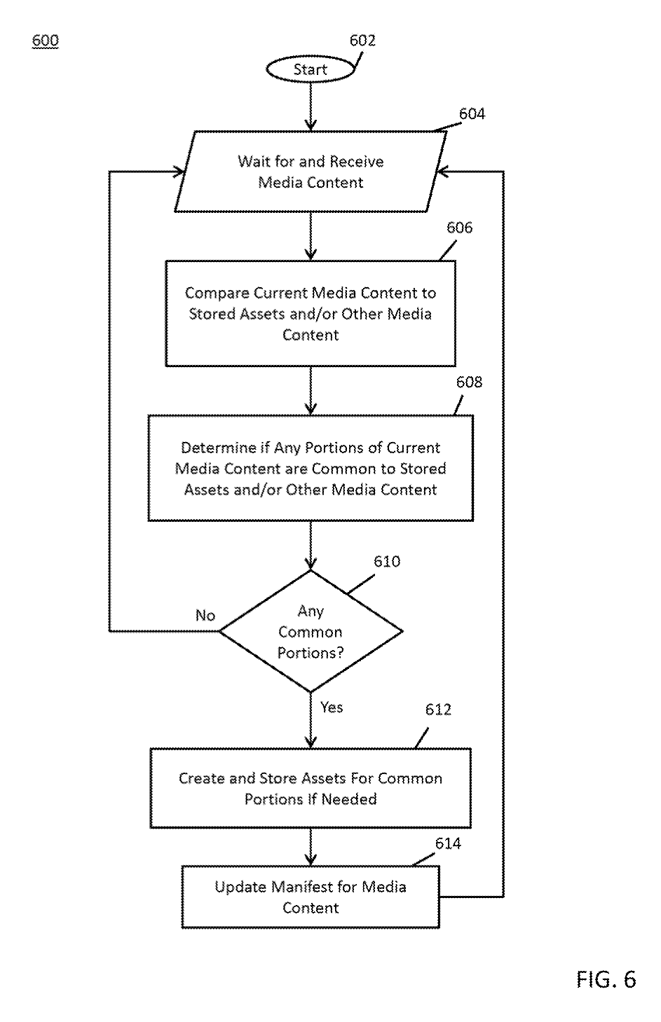

As illustrated in FIG. 2, in some embodiments, media content source 216 can include an ingestion process 234, a media delivery process 236, asset storage 238, manifest storage 240, and/or any other suitable additional or alternative processes, functions, etc. Ingestion process 234 can be any suitable process for receiving media content and determining what portions, if any, can be cached locally to a user equipment device. An example of a process is shown in FIG. 6, which is described further below.

Media content delivery process 236 can be any suitable process for delivering media content to user equipment devices. For example, process 236 can be a process that receives a request for media content playback from a user equipment device, that transmits a manifest for the media content to the user equipment device, that sets-up media streaming to the user equipment device, and that streams media content to the user equipment device.

Asset storage 238 can be airy suitable storage mechanism for storing assets for media content. For example, asset storage can be a media server, a disk drive, a database, etc. Although asset storage 238 is illustrated as being part of streaming media source 216 in FIG. 2, in some embodiments, the storage 238 can be separate from source 216.

Manifest storage 240 can be any suitable storage mechanism for storing manifests for media content. For example, manifest storage can be a disk drive, a database, etc. Although manifest storage 240 is illustrated as being part of streaming media source 216 in FIG. 2, in some embodiments, the storage 240 can be separate from source 216.

Media guidance data source 218 may provide any suitable media guidance data, such as names of pieces of media content, times at which the media content is available (if applicable), sources (e.g., channels, Web addresses, etc.) from which the media content, can be obtained, parental ratings for the pieces of media content, durations of the pieces of media content, descriptions of the pieces of media content, reviews or quality ratings of the pieces of media content, and/or any other suitable information.

Media guidance data may be provided by media guidance data source 218 to the user equipment devices using any suitable approach. In some embodiments, for example, an interactive media guidance application may be a stand-alone interactive television program guide that receives this media guidance data from media guidance data source 218 via a data feed (e.g., a continuous feed or trickle feed). In some embodiments, this media guidance data may be provided to the user equipment on a television channel sideband, using an in-band digital signal, using an out-of-band digital signal, or by any other suitable data transmission technique from media guidance data source 218. In some embodiments, this media guidance data may be provided to user equipment on multiple analog or digital television channels from media guidance data source 218. In some embodiments, media guidance data from media guidance data source 218 may be provided to users' equipment using a client-server approach, wherein media guidance data source 218 acts as a server.

Cloud-based storage 230 can be any suitable storage for storing assets, manifests, and/or any other suitable content, data, etc. so that it is accessible via communication network 214. In some embodiments, cloud-based storage 230 can be virtualized pools of storage hosted in an Internet data center, such as the Amazon S3 storage provided by Amazon Web Services of Herndon, Va., USA. In some embodiments, cloud-based storage 230 can be used to “locally” cache assets for presentation on user equipment devices 202, 204, and/or 206 rather than store that content in caches 228 of user equipment devices 202, 204, and/or 206.

Although only one each of user equipment-devices 202, 204, and/or 206, sources 216 and 218, and storage 230 are illustrated in FIG. 2 in order to avoid over complicating the drawing, any suitable number of each of these components can be provided in some embodiments. Each user may utilize more than one type of user equipment device in some embodiments. In some embodiments, any of user equipment devices 202, 204, and 206 can be combined, and any of sources 216 and 218 can be combined.

Paths 206, 210, 212, 220, 222, and 232 may separately or together include one or more communications paths, such as, a satellite path, a fiber-optic path, a cable path, a path that supports Internet communications (e.g., IPTV), free-space connections (e.g., for broadcast or other wireless signals), or any other suitable wired or wireless communications path or combination of such paths. Path 212 is drawn with dotted lines to indicate that, in the exemplary embodiment shown in FIG, 2, it can be a wireless path (although this path may be a wired path, if desired), and paths 208, 210, 220, 222, and 232 are drawn as solid lines to indicate they can be wired paths (although these paths may be wireless paths, if desired). Communication to/from user equipment devices 202, 204, and 206, sources 216 and 218, and storage 230 may be provided by one or more of communications paths 208, 210, 212, 220, 222, and 232, respectively, but are shown as a single path in FIG. 2 to avoid overcomplicating the drawing.

Although communications paths are not drawn between user equipment devices 202, 204, and 206, sources 216 and 218, and storage 230, these components may communicate directly with each other via communication paths, such as those described above, as well via point-to-point communication paths, such as USE cables, IEEE 1394 cables, wireless paths (e.g., Bluetooth, infrared, IEEE 802.11x, etc.), or other communication via wired or wireless paths. BLUETOOTH is a certification mark owned by Bluetooth SIG, INC. The user equipment devices 202, 204, and 206, sources 216 and 218, and storage 230 may also communicate with each other directly through an indirect path via communications network 214.

In some embodiments, sources 216 and 218 and storage 230 can be implemented in any suitable hardware. For example, sources 216 and 218 and storage 230 can be implemented in any of a general purpose device such as a computer or a special purpose device such as a client, a server, mobile terminal (e.g., mobile phone), etc. Any of these general or special purpose devices can include any suitable components such as a hardware processor (which can be a microprocessor, digital signal processor, a controller, etc.), memory, communication interfaces, display controllers, input devices, etc.

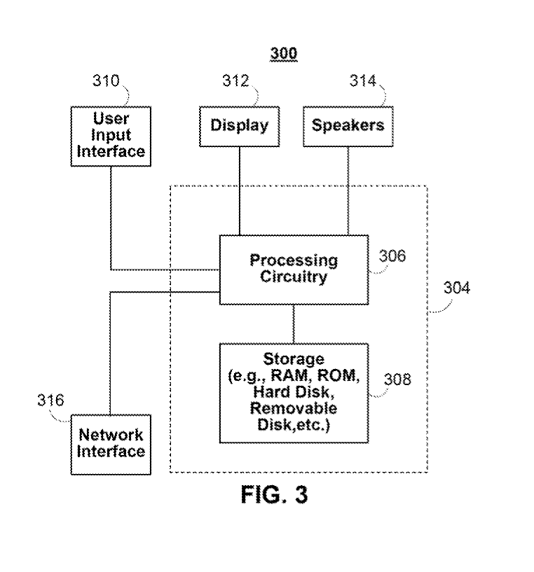

FIG. 3 shows an example of hardware that can be provided in an illustrative user equipment device 300, such as user television equipment device 202, user computer equipment device 204, and/or wireless user communication device 206 of FIG. 2, in accordance with some embodiments. As illustrated, device 300 can include control circuitry 304 (which can include processing circuitry 306 and storage 308), a user input interface 310, a display 312, speakers 314, and an input/output (hereinafter “I/O”) interface 316.

Control circuitry 304 may include any suitable processing circuitry such as processing circuitry 306. As referred to herein, processing circuitry 306 can be circuitry that includes one or more microprocessors, microcontrollers, digital signal processors, programmable logic devices, field-programmable gate arrays (FPGAs), application-specific integrated circuits (ASICs), hardware processors, etc., and may include a multi-core processor (e.g., dual-core, quad-core, hexa-core, or any suitable number of cores) or a supercomputer, in some embodiments. In some embodiments, processing circuitry may be distributed across multiple separate processors or processing units, such as, for example, multiple of the same type of processing units (e.g., two Intel Core i7 processors) or multiple different processors (e.g., an Intel Core i5 processor and an Intel Core i7 processor).

Storage 308 can foe any suitable digital storage mechanism in some embodiments. For example, storage 308 can include any device for storing electronic data, program instructions, computer software, firmware, register values, etc., such as random-access memory, read-only memory, hard drives, optical drives, digital video disc (DVD) recorders, compact disc (CD) recorders, BLU-RAY disc (BD) recorders, BLU-RAY 3D disc recorders, digital video recorders (DVR, sometimes called a personal video recorder, or PVR), solid state devices, quantum storage devices, gaming consoles, gaming media, or any other suitable fixed or removable storage devices, and/or any combination of the same. Storage 308 may be used to store media content, media guidance data, executable instructions (e.g., programs, software, scripts, etc.) for providing an interactive media guidance application, and for any other suitable functions, and/or any other suitable data or program code, in accordance with some embodiments. Nonvolatile memory may also be used (e.g., to launch a boot-up routine and other instructions). Cloud-based storage may be used to supplement storage 308 or instead of storage 308 in some embodiments.

Control circuitry 304 may include video generating circuitry and tuning circuitry, such as one or more analog tuners, one or more MPEG-2 decoders or other digital decoding circuitry, high-definition tuners, or any other suitable tuning or video circuits or combinations of such circuits. Encoding circuitry (e.g., for converting over-the-air, analog, or digital signals to MPEG signals for storage) may also be provided. Control circuitry 304 may also include scaler circuitry for reconverting and downconverting content into the preferred output format of the user equipment 300. Circuitry 304 may also include digital-to-analog converter circuitry and analog-to-digital converter circuitry for converting between digital and analog signals. The video generating circuitry may be used for presenting media content. The tuning and encoding circuitry may foe used by the user equipment device to receive and to display, to play, or to record content. The tuning and encoding circuitry may also be used to receive guidance data. The circuitry described herein, including for example, the tuning, video generating, encoding, decoding, encrypting, decrypting, scaler, and analog/digital circuitry, may be implemented using software running on one or more general purpose or special purpose hardware processors. Multiple tuners may foe provided to handle simultaneous tuning functions (e.g., watch and record functions, picture-in-picture (PIP) functions, multiple-tuner recording, etc.). If storage 308 is provided as a separate device from user equipment 300, the tuning and encoding circuitry (including multiple tuners) may be associated with storage 308.

A user may send instructions to control circuitry 304 using user input interface 310, User input interface 310 may foe any suitable user interface, such as a remote control, mouse, trackball, keypad, keyboard, touch screen, touchpad, stylus input, joystick, voice recognition interface, or other user input interfaces.

Display 312 may foe provided as a stand-alone device or integrated with other elements of user equipment device 300. Display 312 may be one or snore of a monitor, a television, a liquid crystal display (LCD) for a mobile device, or any otter suitable equipment for displaying visual images. In some embodiments, display 312 may be RDTV-capabie. In some embodiments, display 312 may be a 3D display.

A video card or graphics card may generate the output to display 312. The video card may offer various functions such as accelerated rendering of 3D scenes and 2D graphics, MPEG-2/MPEG-4 decoding, TV output, or the ability to connect multiple monitors. The video card may be any processing circuitry described above in relation to control circuitry 304. The video card may be integrated with the control circuitry 304 or may be integrated with display 312.

Speakers 314 may be provided as integrated with other elements of user equipment device 300 or may be stand-alone units. The audio component of media content displayed on display 312 may be played through speakers 314. In some embodiments, the audio may be distributed to a receiver (not shown), which processes and outputs the audio via speakers 314.

I/O interface 316 can be any suitable I/O interface 316 in some embodiments. For example, in some embodiments, I/O interface 316 can be airy suitable interface for coupling control circuitry 304 (and specifically processing circuitry 306) to one or more communications paths (e.g., paths 208, 210, and 212 described in FIG. 2). More particularly, for example, I/O interface 316 can include a cable modem, an integrated services digital network (ISDN) modem, a digital subscriber line (DSL) modem, a telephone modem, an Ethernet card, a fiber-optic modem, a wireless modem, and/or any other suitable communications circuitry. In some embodiments, the I/O interface can foe used to provide content and data from an external location to device 300. For example, in some embodiments, I/O interface 316 can be used to provide media content (e.g., broadcast programming, on-demand programming, Internet content, content available over a local area network (LAN) or wide area network (WAN), and/or any other suitable content), media guidance data, subtitles, time codes, and/or any other suitable information or data to control circuitry 304 of device 300. In some embodiments, I/O interface 316 can also foe used to send and receive commands, requests, and. other suitable data from and to, respectively, control circuitry 304. Any suitable number of I/O interfaces 316 can be provided, even though only one is shown in FIG. 3 to avoid overcomplicating the drawing.

The processes for caching assets and playing back media content, the interactive media guidance application, and/or any other suitable functions as described herein may be implemented as stand-alone applications on user equipment devices in some embodiments. For example, the processes for caching assets, playing back media content, and/or the interactive media guidance application may be implemented as software or a set of executable instructions which may foe stored in storage 308, and executed by control circuitry 304 of a user equipment device 300.

In some embodiments, the processes for caching assets, playing back media content, the interactive media guidance application, and/or any other suitable functions as described herein may be implemented as client-server applications. In such client-server applications, a client application may reside on a user equipment device, and a server application may reside on a remote server, such as source 216. For example, the processes for caching assets and playing back media content may be implemented partially as a client application on control circuitry 304 of user equipment device 300 and partially as a server application media content source 216. As another example, an interactive media guidance application may be implemented partially as a client application on control circuitry 304 of user equipment device 300 and partially on a remote server (e.g., media guidance data source 218 of FIG. 2) as a server application running on control circuitry of the remote server.

FIG. 4 illustrates an example 400 of a process for caching assets that can be used in a user equipment device in some embodiments. At least part of a process that performs what is described in FIG. 4, and herein in connection with those figures, can be stored as executable instructions in storage 300 and executed at least in part in control circuitry 304 of a user equipment device 300.

As shown, after process 400 begins at 402, control circuitry 304 can determine whether there are any assets to cache at 404. This determination can foe made in any suitable manner. For example, in some embodiments, control circuitry 304 can determine that there is an asset to cache if a cachable asset is being streamed to the user equipment device running process 400, if an asset stored on streaming media content source 202, another user equipment device, or cloud-based storage is ready to foe cached, etc. If it is determined that there are no assets to cache at 404, then process can loop back to 404.

Otherwise, if it is determined at 404 that there is an asset to cache, then control circuitry 304 can determine at 406 whether there is space in the cache to store cachable assets. This determination can be made in any suitable manner. For example, in some embodiments, this determination can be made based, on an anticipated size of an asset to foe cached. if it is determined that there is no space, then control circuitry 304 can determined at 408 if there are any expired cache assets. This determination can be made in any suitable manner. For example, an asset can expire based on how long the asset has been in the cache, based on when the asset was created, based on a fixed point in time, based on whether the underlying-media content is still available, etc. If so, then control circuitry 304 can delete the expired assets at 410. Expired assets can be deleted in any suitable manner. For example, the oldest expired assets can foe deleted, all expired assets can be deleted, only expired assets big enough to create space for the cachable assets can foe deleted, etc. Otherwise, if it is determined at 408 that there are no expired cache assets, then control circuitry 304 can determine whether to delete an unexpired asset or to skip caching of the cachable assets at 412. This determination can be made in any suitable manner. For example, in some embodiments, this determination can be made based on a priority of the cachable assets and a priority of cached assets. If the cached assets have lower priority, then the cached assets can be deleted. If it is determined that cached assets are to be deleted, then control circuitry 304 can delete those assets at 414. Otherwise, if it is determined at 412 that caching of the cachable assets is to be skipped, process 400 can loop back to 404.

After deleting expired assets at 410 or selecting an asset to delete at 414, process 400 can loop back to 406 to re-check the space in the cache.

If it is determined that there is sufficient space in the cache at 406, then control circuitry 304 can determine if a cachable asset is streaming to the user equipment device at 416. A cachable asset may be streaming because a viewer of the asset may be streaming the asset while watching it, for example.

If it is determined at 416 that a cachable asset is not being streamed, then control circuitry 304 can identify a cachable asset to retrieve at 418. This identification can be made in any suitable manner. For example, a cachable asset can be identified by checking whether media content source 216, another user equipment device 202, 204, or 206, or cloud-based storage 230 has an asset ready to be cached and requesting the identity of that asset. As another example, a cachable asset can be identified by the user equipment device determining that a certain cachable asset is likely to be needed for playback (e.g., based on typical viewing habits of a user or other users, based on reminder settings, etc.) and by determining that that asset is available on streaming media source 216, another user equipment device 202, 204, or 206, or cloud-based storage 230.

Next at 420, control circuitry 304 can request and receive the cachable asset.

Then, after receiving the asset at 420 or after determining that a cachable asset, is being streamed to the user equipment device at 416, control circuitry 304 can store the cachable asset at 422. The cachable asset can be stored in any suitable manner and in any suitable location. For example, the cachable asset can be stored as a file in cache 228 and/or cloud-based storage 230.

It should be understood that the above steps of the flow diagram of FIG. 4 may foe executed or performed in any order or sequence not limited to the order and sequence shown and described in the figure. Also, some of the above steps of the flow diagram of FIG. 4 may foe executed or performed substantially simultaneously where appropriate or in parallel to reduce latency and processing times.

Turning to FIG. 5, an example 500 of a playback process that can be implemented in a user equipment 202, 204, and/or 206 in accordance with some embodiments is shown. At least part of a process that performs what is described in FIG. 5, and herein in connection with those figures, can be stored as executable instructions in storage 308 and executed at least in part in control circuitry 304 of a user equipment device 300.

As illustrated, after process 500 begins at 502, control circuitry 304 can wait for a request for media content playback at 504. This request can be received in any suitable manner in some embodiments. For example, this request can be received as an indication that a user selected media content from a list of media content in a program guide in some embodiments. Next, at 506, control circuitry 304 can receive a media content selection. This content selection can foe received in any suitable manner. For example, in some embodiments, the selection can be received based on a particular selection of media content from a list of media content in a program guide in some embodiments.

Control circuitry 304 can then request and receive a manifest of assets associated with the selected media content, at 508. This manifest can be received in any suitable manner and can take any suitable form. For example, in some embodiments, this manifest can be received as a Synchronized Multimedia Integration language (SMIL) document, XML file, etc.

At 510, control circuitry 304 can select a next asset in the manifest as the current asset. For example, a first asset in the manifest can initially be selected as the current asset. Subsequently, assets can be selected in an order in which they should be presented during playback of the media content.

Control circuitry 304 can then determine at 512 if the current asset is cachable. This determination can foe made in any suitable manner. For example, in some embodiments, an asset can foe determined as being cashable if it is determined that the asset may be presented to the user more than once before its expiration. If it is determined that an asset is not cachable, then control circuitry 304 can request and receive the current asset at 514 and then begin playback of the asset at 516, Playback can be begun in any suitable manner.

Otherwise, if it is determined that an asset is cashable, control circuitry 304 can determine at 518 if the asset is stored locally and playable. These determinations can be made in any suitable manner. For example, in some embodiments, an asset can be determined as being stored locally if it is stored in a local cache (such as cache 228 of FIG. 2) or stored in cloud-based storage 230. If it is determined that the asset is stored locally and playable, then process 500 can branch to 556 to begin playback of the asset.

Otherwise, if it is determined that the asset is not stored locally and/or not playable, then control circuitry 304 can determine whether the asset can be skipped at 520. If the asset cannot be skipped, then control circuitry 304 can request and receive the asset at 522.

Otherwise, if it is determined that the asset can be skipped at 520, or after beginning playback of the asset at 516, then control circuitry 304 can determine if the current asset is the last asset for the media content at 524. This determination can be made in any suitable manner in some embodiments. For example, this determination can be made based on the contents of the manifest. If it is determined that the current asset is not the last asset for the media content, then process 500 can branch back to 510 to select the next asset. Otherwise, process 500 can branch to 504 to wait for another request for media content playback.

It should be understood that the above steps of the flow diagram of FIG. 5 may be executed or performed in any order or sequence not limited to the order and sequence shown and described in the figure. Also, some of the above steps of the flow diagram of FIG. 5 may be executed or performed substantially simultaneously where appropriate or in parallel to reduce latency and processing times,

FIG. 6 illustrates an example 600 of a process for ingesting a piece of media content for subsequent playback that can be performed at a media content source, such as source 216, in accordance with some embodiments. At least part of a process that performs what is described in FIG. 6, and herein in connection with those figures, can be stored as executable instructions in storage of source 216 and executed at least in part in control circuitry of source 216.

As shown, after process 600 begins at 602, control circuitry can wait for and receive a piece of media content. This media content can be received in any suitable manner. For example, in some embodiments, this media content, can be received as a mezzanine file in any suitable format.

Next, at 606, control circuitry can compare the current media content to stored assets and/or other media content. This comparison can be made in any suitable manner. For example, the media content, can be compared to assets (e.g., using fingerprinting) to determine if a portion of the media content is the same as or similar to one or more assets in some embodiments. As another example, in some embodiments, the media content can be compared to other media content to determine if one or more portions of the media contents are the same.

Control circuitry can then determine whether there are any common portions between the media content and the assets and/or other media content at 608. if there are no common portions, then process 600 can loop back to 604 to wait for and receive more media content. Otherwise, control circuitry can create and store assets for common portions of the media content, if necessary, at 610. For example, if two pieces of media content are determined to have the same introduction segment, then an asset for the introduction segment can foe generated and stored. Then at 612, control circuitry can update the manifest for the media content to reflect that the asset for the common portion (s) can foe selected for playback, and then process 600 can loop back to 604 to wait for and receive more media content.

It should foe understood that the above steps of the flow diagram of FIG. 6 may foe executed or performed in any order or sequence not limited to the order and sequence shown and described in the figure. Also, some of the above steps of the flow diagram of FIG. 6 may foe executed or performed substantially simultaneously where appropriate or in parallel to reduce latency and processing times.

In some embodiments, any suitable computer readable media can foe used for storing instructions for performing the mechanisms and/or processes described herein. For example, in some embodiments, computer readable media can foe transitory or non-transitory. For example, non-transitory computer readable media can include media such as magnetic media (such as hard disks, floppy disks, etc.), optical media (such as compact discs, digital video discs, Blu-ray discs, etc.), semiconductor media (such as flash memory, electrically programmable read only memory (EPROM), electrically erasable programmable read only memory (EEPROM), etc.), any suitable media that is not fleeting or devoid of any semblance of permanence during transmission, and/or any suitable tangible media. As another example, transitory computer readable media can include signals on networks, in wires, conductors, optical fibers, circuits, any suitable media that is fleeting and devoid of any semblance of permanence during transmission, and/or any suitable intangible media.

The above described embodiments of the present disclosure are presented for purposes of illustration and not of limitation, and the present disclosure is limited only by the claims which follow.

What is claimed is:

1. A system for presenting media content using cached assets, the system comprising:
processing circuitry configured to:
store a portion of a piece of media content common to a plurality of different pieces of media content;
after storing the portion of the piece of media content common to the plurality of different pieces of media content, receive a user request to present one of the plurality of different pieces of media content;
access a manifest for the one of the plurality of different pieces of media content;
based on the manifest determine that the portion of the media content common to the plurality of different pieces of media content is part of the one of the plurality of different pieces of media content;
play back the portion of the piece of media content common to the plurality of different pieces of media content; and
while playing back the portion of the piece of media content common to the plurality of different pieces of media content, establish a stream of another piece of the one of the plurality of different pieces of media content.

2. The system of claim 1, wherein the portion of the piece of media content common to the plurality of different pieces of media content includes audio and video.

3. The system of claim 1, wherein the portion of the piece of media content common to the plurality of different pieces of media content includes audio but not video.

4. The system of claim 1, wherein the portion of the piece of media content common to the plurality of different pieces of media content includes video but not audio.

5. The system of claim 1, wherein the portion of the piece of media content common to the plurality of different pieces of media content is a first portion of the one of the plurality of different pieces of media content.

6. The system of claim 1, wherein the processing circuitry is also configured to receive the portion of the media content common to the plurality of different pieces of media content.

7. The system of claim 6, wherein the portion of the media content common to the plurality of different pieces of media content is received as part of another piece of media content.

8. The system of claim 6, wherein the portion of the media content common to the plurality of different pieces of media content is received separately from any other piece of media content.

9. A method for presenting media content using cached assets, the method comprising:
storing a portion of a piece of media content common to a plurality of different pieces of media content by processing circuitry;
after storing the portion of the piece of media content common to the plurality of different pieces of media content, receiving a user request to present one of the plurality of different pieces of media content at the processing circuitry;
accessing a manifest for the one of the plurality of different pieces of media content by the processing circuitry;
based on the manifest, determining that, the portion of the media content, common to the plurality of different pieces of media content is part of the one of the plurality of different pieces of media content by the processing circuitry;
playing back the portion of the piece of media content common to the plurality of different pieces of media content by the processing circuitry; and
while playing back the portion of the piece of media content common to the plurality of different pieces of media content, establishing a stream of another piece of the one of the plurality of different pieces of media content by the processing circuitry.

10. The method of claim 9, wherein the portion of the piece of media content common to the plurality of different pieces of media content includes audio and video.

11. The method of claim. 9, wherein the portion of the piece of media, content common to the plurality of different pieces of media content includes audio but not video.

12. The method of claim 9, wherein the portion of the piece of media content common to the plurality of different pieces of media content includes video but not audio.

13. The method of claim 9, wherein the portion of the piece of media content common to the plurality of different pieces of media content is a first portion of the one of the plurality of different pieces of media content.

14. The method of claim 9, further comprising receiving the portion of the media content common to the plurality of different pieces of media content.

15. The method of claim 14, wherein the portion of the media content common to the plurality of different pieces of media content is received as part of another piece of media content.

16. The method of claim 14, wherein the portion of the media content common to the plurality of different pieces of media content is received separately from any other piece of media content.

17. A non-transitory computer-readable medium containing computer-executable instructions that, when executed by a processor, cause the processor to perform a method for presenting media content using cached assets, the method comprising:
storing a portion of a piece of media content common to a plurality of different pieces of media content;
after storing the portion of the piece of media content common to the plurality of different pieces of media content, receiving a user request to present one of the plurality of different pieces of media content;
accessing a manifest for the one of the plurality of different pieces of media content;
based on the manifest, determining that the portion of the media content common to the plurality of different pieces of media content is part of the one of the plurality of different pieces of media content;
playing back the portion of the piece of media content common to the plurality of different pieces of media content; and
while playing back the portion of the piece of media content common to the plurality of different pieces of media content, establishing a stream of another piece of the one of the plurality of different pieces of media content.

18. The non-transitory computer-readable medium of claim 17, wherein the portion of the piece of media content common to the plurality of different pieces of media content includes audio and video.

19. The non-transitory computer-readable medium of claim 17, wherein the portion of the piece of media content common to the plurality of different pieces of media content includes audio but not video.

20. The non-transitory computer-readable medium of claim 17, wherein the portion of the piece of media content common to the plurality of different pieces of media content includes video but not audio.

21. The non-transitory computer-readable medium of claim 17, wherein the portion of the piece of media content common to the plurality of different pieces of media content is a first portion of the one of the plurality of different pieces of media content.

22. The non-transitory computer-readable medium of claim 17, wherein the method further comprises receiving the portion of the media content common to the plurality of different pieces of media content.

23. The non-transitory computer-readable medium of claim 22, wherein the portion of the media content common to the plurality of different pieces of media content is received as part of another piece of media content.

24. The non-transitory computer-readable medium of claim 22, wherein the portion of the media content common to the plurality of different pieces of media content is received separately from any other piece of media content.
